(19) United States
(12) Patent Application Publication
(10) Pub. No.: US 2015/0000083 A1
(43) Pub. Date: Jan. 1, 2015

(54) HINGE ASSEMBLY

(71) Applicant: Paul J. Gwin, Orangevale, CA (US)

(72) Inventor: Paul J. Gwin, Orangevale, CA (US)

(21) Appl. No.: 13/931,444

(22) Filed: Jun. 28, 2013

(51) Int. Cl. E05D 11/00; E05D 3/02

(52) U.S. Cl. CPC E05D 11/00; E05D 3/02
USPC 16/321

(57) ABSTRACT

In one embodiment a chassis for an electronic device comprises a first section and a second section, the second section coupled to the first section by a hinge, a first resistance element to provide a first rotational resistance in a first angular range from a resting position, and a second resistance element to provide a second rotational resistance, greater than the first rotational resistance, in a second angular range, wherein the first resistance element operates independently of the second resistance element. Other embodiments may be described.

### BACKGROUND

The subject matter described herein relates generally to the field of electronic devices and more particularly to hinge assemblies which may be used with electronic devices.

Some electronic devices utilize a notebook chassis. By way of example, many portable computers (e.g. traditional laptop, detachable, or convertible) and mobile electronic devices utilize a notebook chassis in which a keyboard is disposed on a first section and a display is disposed on a second section which is coupled to the first section by a hinge. Alternatively, a “clamshell” style laptop can consist of displays, e.g. at least one display on a first section and possibly one or more displays, that can also be utilized as a touch keyboard, on a second section coupled to the first section by a hinge.

Touch screen user interfaces are becoming increasingly common with all electronic devices, and most notably with mobile devices. In some instances, touch screen operation may cause the display to oscillate due to the force applied to the screen by the user. Accordingly, hinge assemblies which manage the rotation of a display on a chassis for an electronic device may find utility.

### BRIEF DESCRIPTION OF THE DRAWINGS

The detailed description references the accompanying figures.

FIG. 1A-1B are schematic illustrations of an exemplary electronic device which may include a hinge assembly in accordance with some embodiments.

FIG. 2 is a schematic block diagram of an exemplary electronic device which may include a hinge assembly in accordance with some embodiments.

FIG. 3A is a plan view and FIG. 3B is a side view of a hinge assembly in accordance with some embodiments.

FIGS. 4A-4G are schematic illustrations of resistance elements which may be incorporated into a hinge assembly in accordance with some embodiments.

FIG. 5 is a schematic illustration of a resistance element which may be incorporated into a hinge assembly in accordance with some embodiments.

FIGS. 6-10 are schematic illustrations of electronic devices which may be modified to include a hinge assembly in accordance with some embodiments.

### DETAILED DESCRIPTION

In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

A common problem in mobile computing devices with rotational displays is an uncontrolled rotational bounce of the display which may be caused by the user touching the display, thereby imparting energy to the display by the touch impulse. This stores energy in display structure, hinge elements, and mass balance of the system. The energy imparted may be at a natural frequency of the display torsional stiffness and the mass of the display. This causes a hyper bounce condition.

Described herein are embodiments of an energy damping system which may be incorporated into a hinge to provide two different hinge rotation resistances which minimize, or at least reduce, the motion of the display from impulse imparted to the display. The damping system comprises two rotational resistance elements which provide two rotational resistances. The first resistance is less than the second and helps to dissipate energy input to the display from touch impulses, such as a user touching the touch screen. The damping mechanism of the first element dissipates the energy in the display and regulates movement of the display so that the display returns to a nominal (e.g., starting position) in a controlled manner to arrest the motion in time for the next impulse from a touch.

The second resistance element has higher resistance than the first element. This allows the display to be rotated to the viewing position desired by the user. When a user touches the screen an impulse is imparted to the display causing the display to rotate about the hinge axis. Because the first resistance is lower than the second, the second resistance element will remain static thereby preserving the nominal position of the display. The second resistance element is rotated when a the display is rotated beyond the rotational range of the first resistance element, at which time the second resistant element begins to rotate and change the nominal position or viewing angle of the display.

Described herein are exemplary systems and methods to provide resistance to the rotation of a hinge, such as may be used for a display on a notebook system chassis. In some embodiments the systems and methods described herein provide a first rotational resistance within a first angular range from a resting position and a second rotational resistance which is greater than the first rotational resistance within a second angular range. When a hinge assembly is incorporated into an electronic device it provides a first angular range from a resting position in which a display can rotate with respect to a base of the electronic device relatively freely in order to dissipate energy imparted when a user touches the display, then return to the resting position. Other features will become evident based upon the following description and drawings.

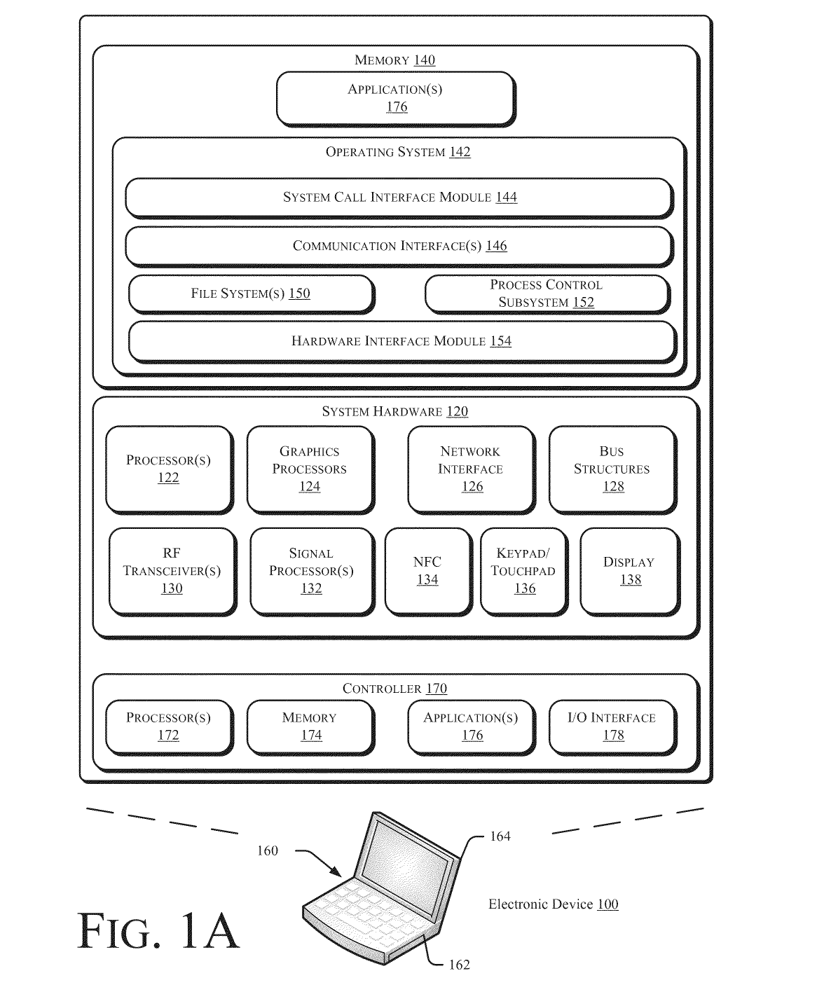

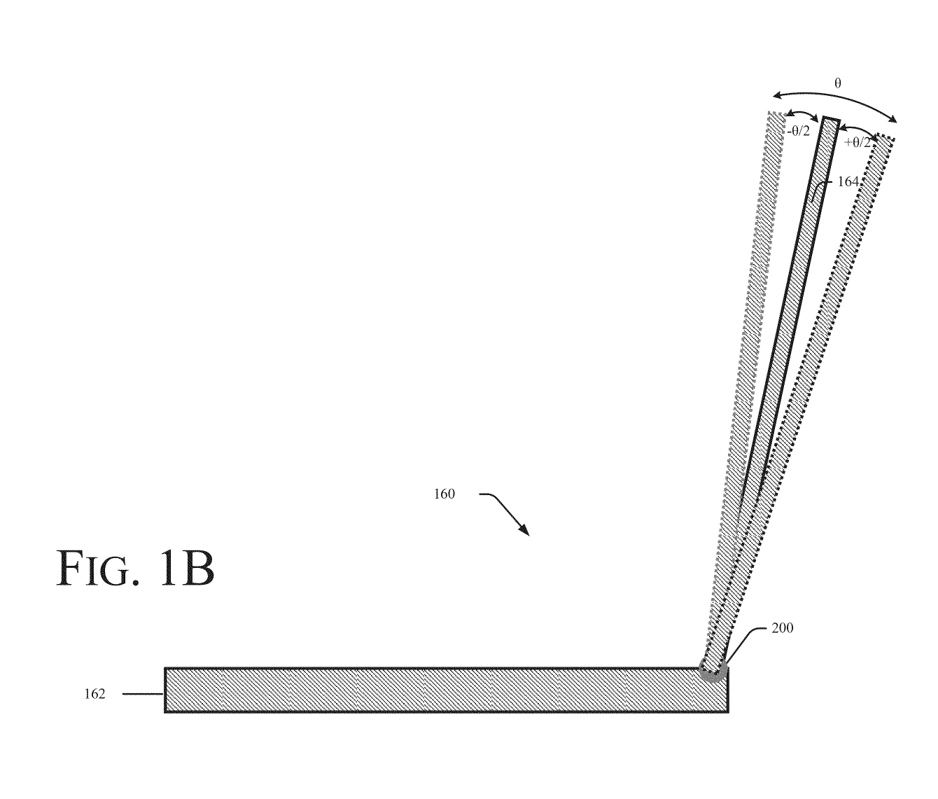

FIG. 1A is a schematic illustration of an exemplary electronic device 100 which may be adapted to include a hinge assembly which manages the rotation of a display on a notebook chassis 160 having a first section 160 and a second section 162 in accordance with some embodiments. As illustrated in FIG. 1, electronic device 100 may be embodied as a conventional portable device such as a laptop computer, a mobile phone, tablet computer portable computer, or personal digital assistant (PDA). The particular device configuration is not critical.

In various embodiments, electronic device 100 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 100 to receive input from a user.

The electronic device 100 includes system hardware 120 and memory 140, which may be implemented as random access memory and/or read-only memory. A file store may be communicatively coupled to electronic device 100. The file store may be internal to electronic device 100 such as, e.g., eMMC, SSD, one or more hard drives, or other types of storage devices. The file store may also be external to electronic device 100 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 100 or may be coupled via an expansion slot on the motherboard or may be located on the same die or same package as the Processing Unit.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 100 may include an RF transceiver 130 to transceive RF signals, a Near Field Communication (NFC) radio 134, and a signal processing module 132 to process signals received by RF transceiver 130. RF transceiver may implement a local wireless connection via a protocol such as, e.g., Bluetooth or 802.11x. IEEE 802.11a, b, g or n-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 100 may further include one or more input/output interfaces such as, e.g., a keypad/touchpad 136 and a display 138. In some embodiments electronic device 100 may not have a keypad and use the touch panel for input.

Memory 140 may include an operating system 142 for managing operations of electronic device 100. In one embodiment, operating system 142 includes a hardware interface module 154 that provides an interface to system hardware 120. In addition, operating system 140 may include a file system 150 that manages files used in the operation of electronic device 100 and a process control subsystem 152 that manages processes executing on electronic device 100.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 130. Operating system 142 may be embodied as a UNIX operating system or any derivative thereof (e.g., Linux, Android, etc.) or as a Windows® brand operating system, or other operating systems.

In some embodiments an electronic device may include a controller 170, which may be separate from the primary execution environment. The separation may be physical in the sense that the controller may be implemented in controllers which are physically separate from the main processors. Alternatively, the separation may logical in the sense that the controller may be hosted on same chip or chipset that hosts the main processors.

By way of example, in some embodiments the controller 170 may be implemented as an independent integrated circuit located on the motherboard of the electronic device 100, e.g., as a dedicated processor block on the same SOC die. In other embodiments the controller 170 may be implemented on a portion of the processor(s) 122 that is segregated from the rest of the processor(s) using hardware enforced mechanisms

In the embodiment depicted in FIG. 1 the controller 170 comprises a processor 172, a memory module 174, a control module 176, and an I/O interface 178. In some embodiments the memory module 174 may comprise a persistent flash memory module and the various functional modules may be implemented as logic instructions encoded in the persistent memory module, e.g., firmware or software. The I/O interface 178 may comprise a serial I/O module or a parallel I/O module. Because the controller 170 is separate from the main processor(s) 122 and operating system 142, the controller 170 may be made secure, i.e., inaccessible to hackers who typically mount software attacks from the host processor 122.

In some embodiments the electronic device 100 may comprise a hinge assembly which couples the first section 162 and the second section 164. As illustrated in FIG. 1B, in some embodiments the systems and methods described herein the hinge assembly 200 provides a first rotational resistance when the second section 164 is rotated within a first angular range identified by θ in FIG. 1B from a resting position and a second rotational resistance which is greater than the first rotational resistance when the second section 164 is rotated in a second angular range which is outside the first angular range. The second section 164 can rotate from a resting position through half the first angular range in a positive direction and through half the first angular range in a negative direction.

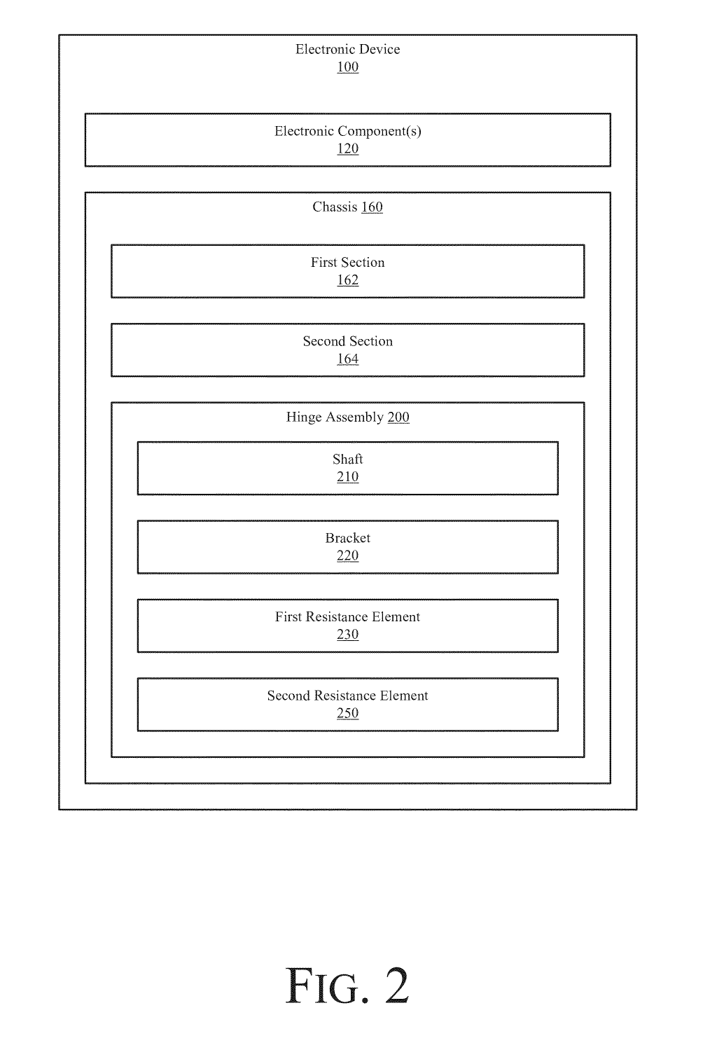

FIG. 2 is a schematic block diagram of an exemplary electronic device which may include a hinge assembly in accordance with some embodiments. Referring to FIG. 2, in some embodiments an electronic device 100 comprises at least one electronic component 120, a chassis 160 comprising a first section 162 and a second section 164, the second section 164 coupled to the first section 162 by a hinge assembly 200. The hinge assembly 200 comprises a shaft 210, a bracket 220 to be rotatably mounted on the shaft 210, a first resistance element 230 to provide a first rotational resistance between the bracket 220 and the shaft 210 in a first angular range from a resting position, and a second resistance element 250 to provide a second rotational resistance between the bracket 220 and the shaft 210, greater than the first rotational resistance, in a second angular range, wherein the first resistance element 230 operates independently of the second resistance element 250.

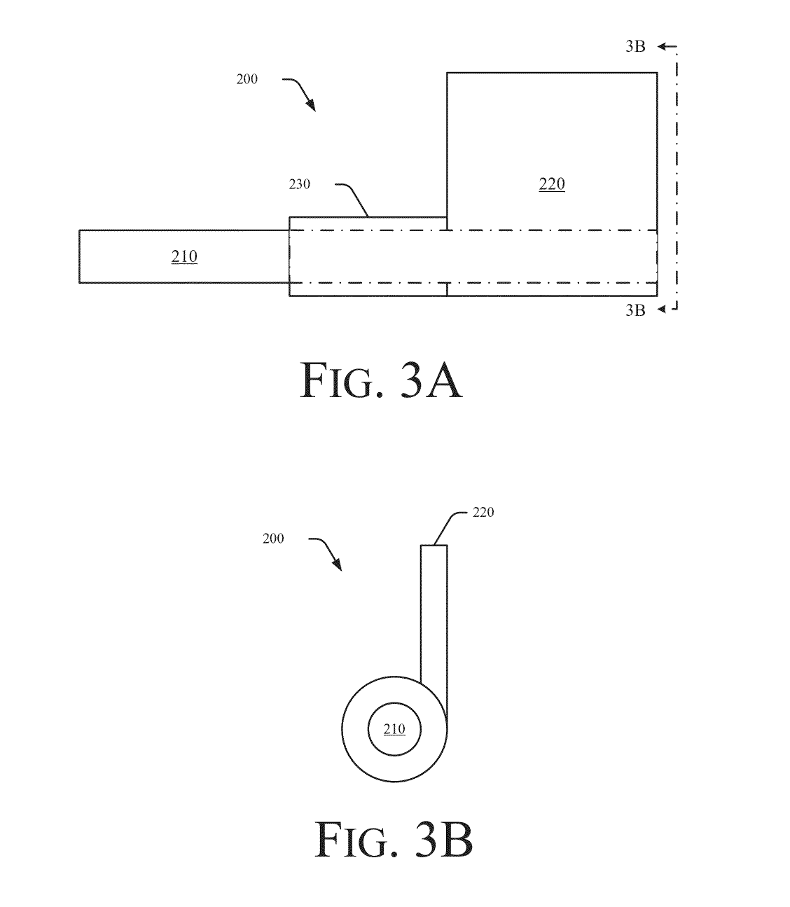

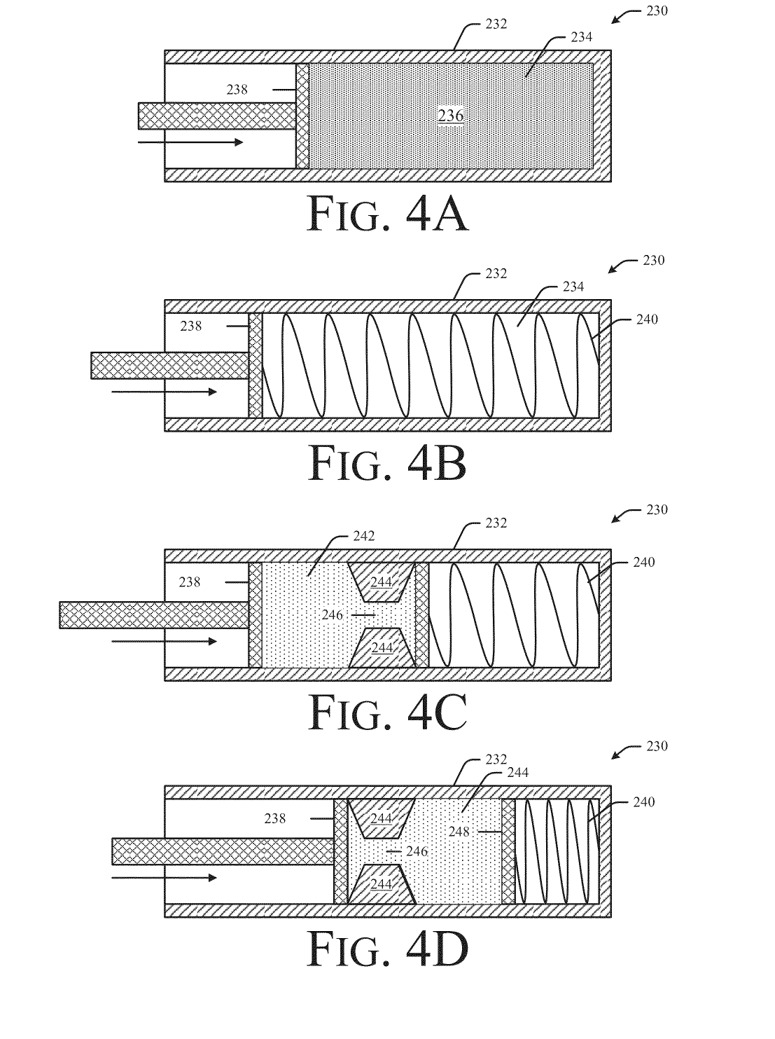

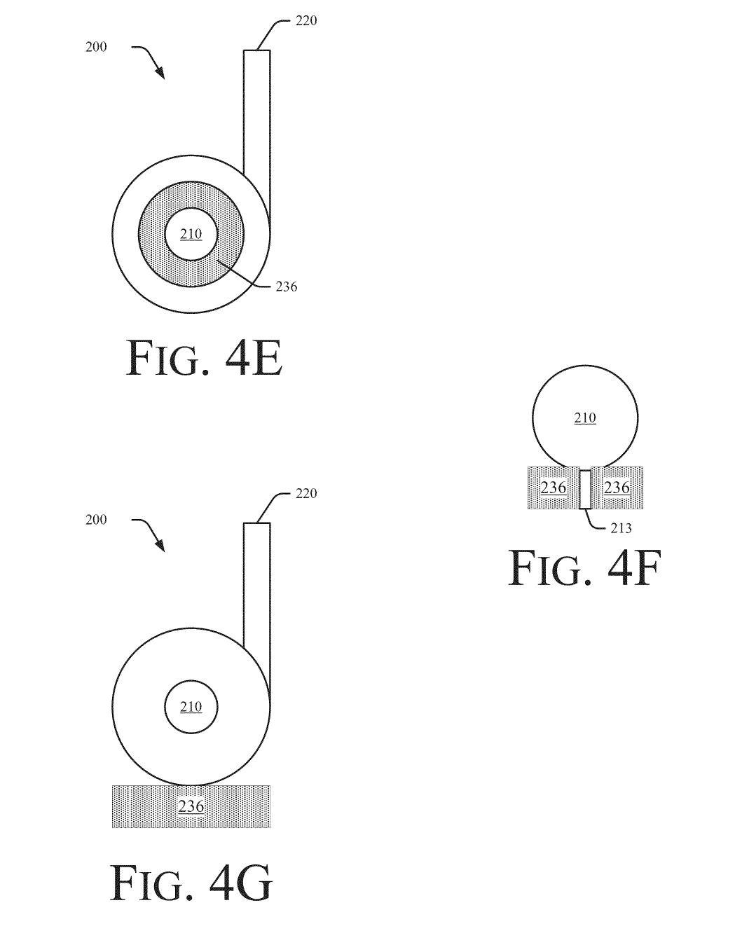

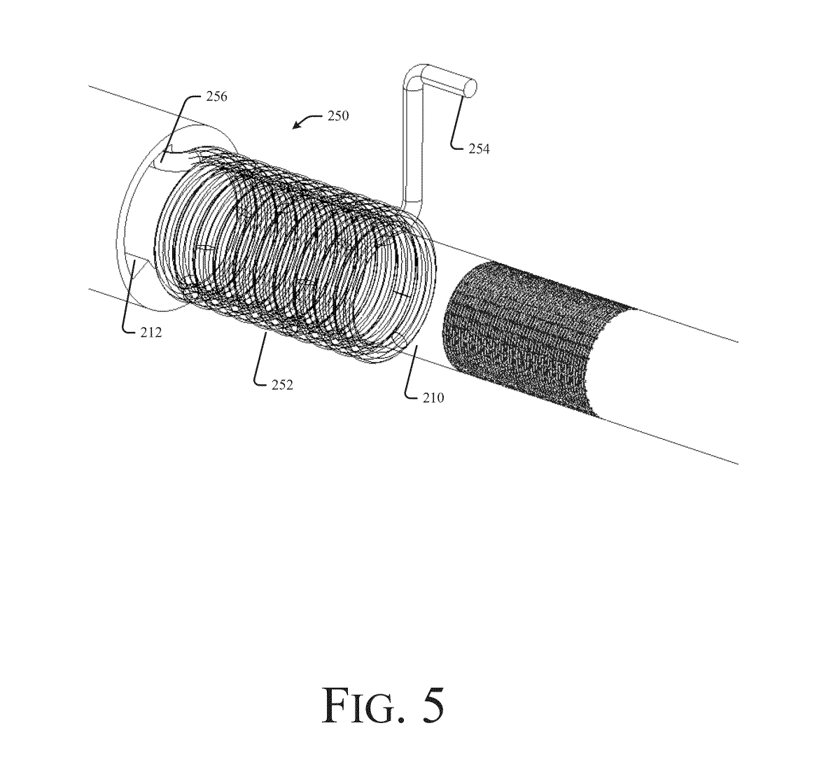

FIG. 3 is a plan view and FIG. 3B is a side view of a hinge assembly 200 in accordance with some embodiments. Referring to FIG. 3A, in some embodiments the hinge assembly 200 comprises a shaft 210 and at least one bracket 220 mounted on the shaft 210 such that the bracket 220 can rotate about the shaft 210. In some embodiments a first resistance element 210 is mounted on the shaft 210 adjacent the bracket 220. Examples of first resistance elements 210 will be described in greater detail with reference to FIGS. 4A-4G.

Referring first to FIG. 4A, in one example a first resistance element 230 comprises a housing 232 defining a chamber 234, a visco-elastic element 236 disposed at a first end of the chamber 234, and a piston 238 disposed at a second end of the chamber 234. Housing 232 may be substantially cylindrical in shape and may have an outer diameter that measures between about 0.25 inches (6.35 millimeters) in and 1.00 inches (25.40 millimeters). The housing 234 may have a length that measures between about 0.50 inches (12.70 millimeters) in and 5.00 inches (127.00 millimeters). Housing 232 may be formed from a suitably rigid material, e.g., a metal, alloy, or rigid polymer.

Visco-elasic element 236 may be formed from any suitable visco-elastic material, e.g., a visco-elastic foam or the like. Piston 238 may be formed from a suitably rigid material, e.g., a metal, alloy, or rigid polymer.

In operation, rotation of the bracket 220 about the shaft 210 within a first angular range translates the piston 238 laterally in the housing 232 on a first side of the chamber 234. Thus, when a hinge assembly 200 comprising a first resistance element 234 is incorporated into an electronic device 100 rotation of the second section 164 of the chassis within the first angular range indicated by θ in FIG. 1B, e.g., by applying pressure as when using a touch screen, causes the piston 238 to compress the visco-elastic foam. When pressure is released from the display the visco-elastic foam restores its original shape, thereby returning the second section 164 to its original position.

Referring first to FIG. 4B, in another example a first resistance element 230 comprises a housing 232 defining a chamber 234, a spring 240 a disposed at a first end of the chamber 234, and a piston 238 disposed at a second end of the chamber 234. Housing 232 may be substantially cylindrical in shape and may have an outer diameter that measures between about 0.25 inches (6.35 millimeters) in and 1.00 inches (25.40 millimeters). The housing 234 may have a length that measures between about 0.50 inches (12.70 millimeters) in and 5.00 inches (127.00 millimeters). Housing 232 may be formed from a suitably rigid material, e.g., a metal, alloy, or rigid polymer. Spring 240 may be formed from any suitably rigid material, e.g., a metal, alloy, or rigid polymer.

In operation, rotation of the bracket 220 about the shaft 210 within a first angular range translates the piston 238 laterally in the housing 232 on a first side of the chamber 234. Thus, when a hinge assembly 200 comprising a first resistance element 234 is incorporated into an electronic device 100 rotation of the second section 164 of the chassis within the first angular range indicated by θ in FIG. 1B, e.g., by applying pressure as when using a touch screen, causes the spring 240 to compress. When pressure is released from the display the spring 240 restores its original shape, thereby returning the second section 164 to its original position.

Referring first to FIGS. 4C-4D, in another example a first resistance element 230 comprises a housing 232 defining a chamber 234 which is to contain a fluid, a spring 240 a disposed at a first end of the chamber 234, and a piston 238 disposed at a second end of the chamber 234. Housing 232 may be substantially cylindrical in shape and may have an outer diameter that measures between about 0.25 inches (6.35 millimeters) in and 1.00 inches (25.40 millimeters). The housing 234 may have a length that measures between about 0.50 inches (12.70 millimeters) in and 5.00 inches (127.00 millimeters). Housing 232 may be formed from a suitably rigid material, e.g., a metal, alloy, or rigid polymer. Spring 240 may be formed from any suitably rigid material, e.g., a metal, alloy, or rigid polymer.

In some embodiments the chamber 230 comprises a first reservoir 242 and a second reservoir 244 connected by a constricted passageway 246. Accordingly, the inner diameter of the housing 220 depicted in FIGS. 2A-2E varies across its length from an inner diameter that measures about 0.08 inches (2 millimeters) in the constricted passageway 246 to an inner diameter that measures about 0.16 inches (4 millimeters) in other locations.

In some embodiments the spring 240 is restrained between a first seal 248 and an housing 232 and biases the first seal 248 in a direction toward the constricted passageway 246. One skilled in the art will recognize that biasing mechanisms other than spring 252 could be used to bias seal 248 in a direction toward the constricted passageway 246. By way of example, compression spring 240 could be replaced with a tension spring positioned in the chamber 230 and secured to first seal 248 to bias the seal 248 in a direction toward the constricted passageway 236. Alternatively, a torsion spring could be coupled to seal 248 to bias seal 248 in a direction toward the constricted passageway 236. In further embodiments a compressible gas, visco-elastic material, or repulsion magnet assembly could be used to bias seal 248 in a direction toward the constricted passageway 236. The specific bias mechanism implemented is not critical to the overall operation of the locking mechanism.

FIG. 4C depicts the state of the first resistance element 230 when in a resting state. In this state the spring 240 applies pressure to the fluid, urging the fluid into the first reservoir 242. Referring to FIG. 4D, rotation of the bracket 220 about the shaft 210 within a first angular range translates the piston 238 laterally in the housing 232 on a first side of the chamber 234, thereby urging the fluid into the second reservoir 244, thereby compressing the spring 240. Thus, when a hinge assembly 200 comprising a first resistance element 234 is incorporated into an electronic device 100 rotation of the second section 164 of the chassis within the first angular range indicated by θ in FIG. 1B, e.g., by applying pressure as when using a touch screen, causes the spring 240 to compress. When pressure is released from the display the spring 240 restores its original shape, which urges the fluid from the second reservoir 244 to the first reservoir 242, thereby returning the second section 164 to its original position.

FIGS. 4E-4G disclose additional examples. Referring to FIG. 4E, in some embodiments a visco-elastic element 236 may be disposed between shaft 210 and bracket 220. Referring to FIG. 4F, in some embodiments a lever 213 may be connected to the shaft 210 to rotate against the visco-elastic elements 236. The lever 213 may protrude outside the shaft 213 and contact the visco-elastic elements 226. Referring to FIG. 4G, in some embodiments the hinge assembly 200 may be mounted on a visco-elastic element 236.

FIG. 5 is a schematic illustration of a second resistance element 250 which may be incorporated into a hinge assembly in accordance with some embodiments. Referring to FIG. 5, in some embodiments the second resistance element 250 comprises a torsion spring 252 which is mounted on shaft 210. Torsion spring comprises a first hook 254 that may be coupled to bracket 220 and a second hook 256 which fits into a slot 212 in shaft 210. Hook 256 is free to rotate within the angular range defined by slot 212. Thus, rotation of the bracket 220 relative to the shaft 210 within the angular range defined by slot 212 does not cause torsion spring 252 to tighten. However, when the bracket 220 is rotated past the end of slot 212, as indicated in FIG. 5, further rotation of the bracket 220 causes torsion spring 252 to tighten, thus providing a second resistance to rotation of the bracket 220 about the shaft 210.

In some embodiments a hinge assembly 200 comprising one or more embodiments of a first resistance element 230 and a second resistance element may be incorporated into a chassis for an electronic device, such as an electronic device 100 depicted in FIG. 1. As described above, the first section 162 may correspond to a base of a laptop personal computer and may comprise a keyboard and one or more additional input output devices. Further, the first section may comprise internal components of a computer system, as described above with reference to FIG. 1. Second section 164 may comprise a display and one or more additional input/output devices, e.g., a touch screen, a microphone, a camera, or the like. In operation, the first resistance element 230 and the second resistance element 250 work independently to provide a first rotational resistance in a first angular range from a resting position and a second rotational resistance in a second angular range.

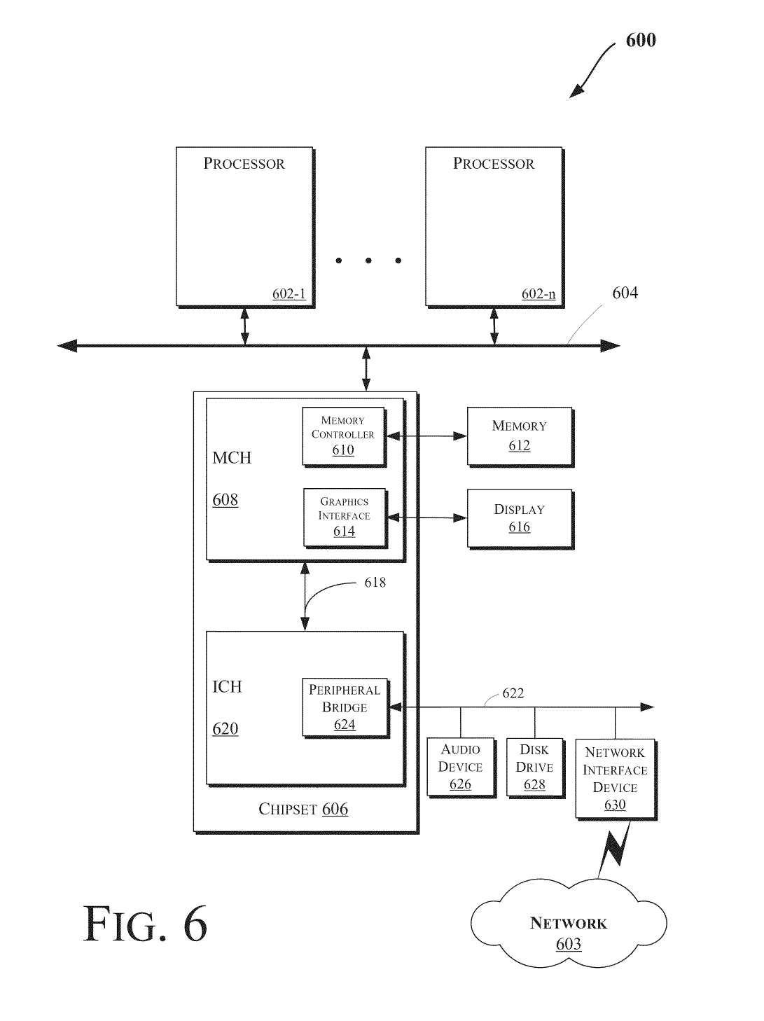

As described above, in some embodiments the electronic device 100 may be embodied as a computer system. FIG. 6 illustrates a block diagram of a computing system 600 in accordance with an embodiment of the invention. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an embodiment, one or more of the processors 602 may be the same or similar to the processors 102 of FIG. 1.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 612 may store data, including sequences of instructions, that may be executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a display device 616. In one embodiment of the invention, the graphics interface 614 may communicate with the display device 616 via an accelerated graphics port (AGP). In an embodiment of the invention, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some embodiments of the invention. In addition, the processor 602 and one or more other components discussed herein may be combined to form a single chip (e.g., to provide a System on Chip (SOC)). Furthermore, the graphics accelerator 616 may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

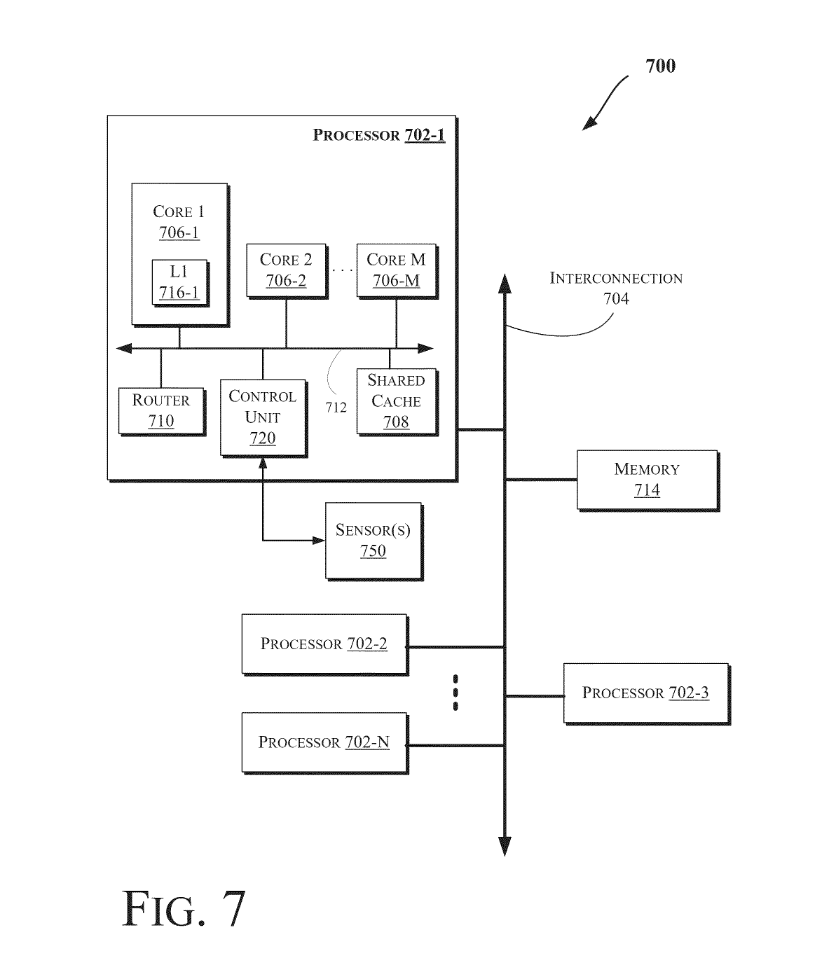

FIG. 7 illustrates a block diagram of a computing system 700, according to an embodiment of the invention. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an embodiment, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one embodiment, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an embodiment, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some embodiments, one or more of the cores 706 may include a level 1 (L1) cache 716-1 (generally referred to herein as “L1 cache 716”). In one embodiment, the controller 720 may include logic to implement the operations described above with reference to FIG. 3.

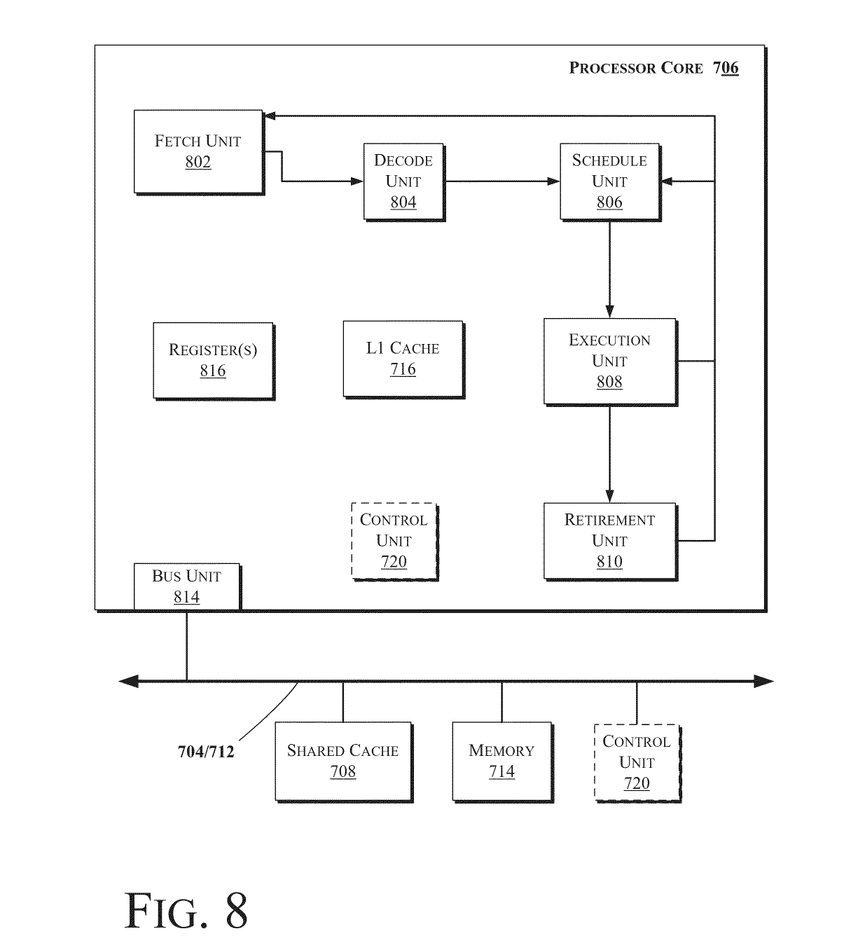

FIG. 8 illustrates a block diagram of portions of a processor core 706 and other components of a computing system, according to an embodiment of the invention. In one embodiment, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one embodiment, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an embodiment, the execution unit 808 may include more than one execution unit. The execution unit 808 may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit 808.

Further, the execution unit 808 may execute instructions out-of-order. Hence, the processor core 706 may be an out-of-order processor core in one embodiment. The core 706 may also include a retirement unit 810. The retirement unit 810 may retire executed instructions after they are committed. In an embodiment, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various embodiments the control unit 720 may be located elsewhere such as inside the core 706, coupled to the core via bus 704, etc.

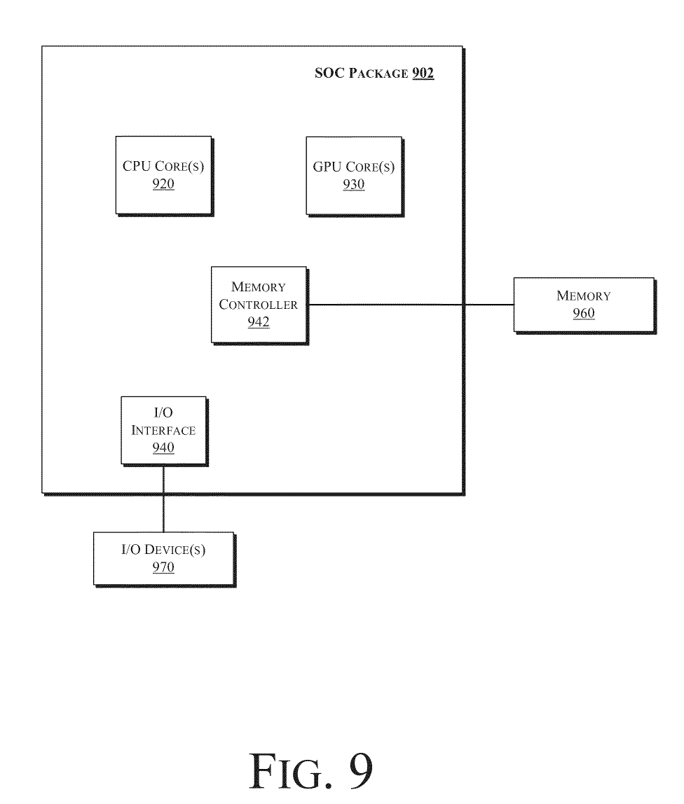

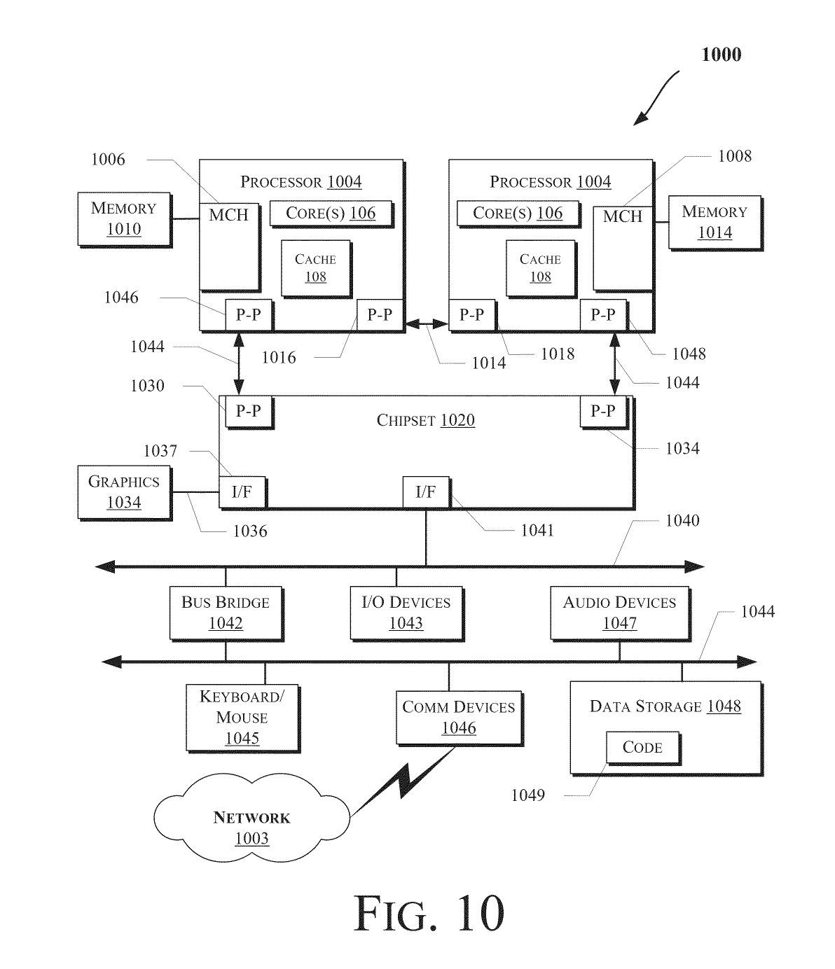

In some embodiments, one or more of the components discussed herein can be embodied as a System On Chip (SOC) device. FIG. 9 illustrates a block diagram of an SOC package in accordance with an embodiment. As illustrated in FIG. 9, SOC 902 includes one or more Central Processing Unit (CPU) cores 920, one or more Graphics Processor Unit (GPU) cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one embodiment, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an embodiment, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch screen, a speaker, or the like.

FIG. 10 illustrates a computing system 1000 that is arranged in a point-to-point (PtP) configuration, according to an embodiment of the invention. In particular, FIG. 10 shows a system where processors, memory, and input/output devices are interconnected by a number of point-to-point interfaces.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic 125 of FIG. 1 in some embodiments.

In an embodiment, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1004. Other embodiments of the invention, however, may exist in other circuits, logic units, or devices within the system 1000 of FIG. 10. Furthermore, other embodiments of the invention may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following examples pertain to further embodiments.

Example 1 is a hinge assembly 200 comprising a shaft 210, a bracket 220 to be rotatably mounted on the shaft 210, a first resistance element 230 to provide a first rotational resistance between the bracket 220 and the shaft 210 in a first angular range from a resting position and a second resistance element 250 to provide a second rotational resistance between the bracket 220 and the shaft 210, greater than the first rotational resistance, in a second angular range, wherein the first resistance element 230 operates independently of the second resistance element 250.

In Example 2, the subject matter of Example 1 can optionally include a housing 232 defining a chamber 234, a visco-elastic element 236 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 3, the subject matter of any one of Examples 1-2 can optionally include a housing 232 defining a chamber 234, a spring 240 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 4, the subject matter of any one of Examples 1-3 can optionally include a housing 232 defining a chamber 234 which is to contain a fluid, a bias mechanism 240 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 5, the subject matter of any one of Examples 1-4 can be arranged such that the first angular range extends in both a positive direction and a negative direction from a resting position.

In Example 6, the subject matter of any one of Examples 1-5 can optionally include a torsion spring.

Example 7 is a chassis for an electronic device comprising a first section and a second section, the second section coupled to the first section by a hinge assembly, the hinge assembly comprising a shaft, a bracket to be rotatably mounted on the shaft, a first resistance element 230 to provide a first rotational resistance between the bracket and the shaft in a first angular range from a resting position, and a second resistance element 250 to provide a second rotational resistance between the bracket and the shaft, greater than the first rotational resistance, in a second angular range, wherein the first resistance element 230 operates independently of the second resistance element 250.

In Example 8, the subject matter of Example 7 can optionally include a housing 232 defining a chamber 234, a visco-elastic element 236 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 9, the subject matter of any one of Examples 7-8 can optionally include a housing 232 defining a chamber 234, a spring 240 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 10, the subject matter of any one of Examples 7-9 can optionally include a housing 232 defining a chamber 234 which is to contain a fluid, a bias mechanism 240 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 11, the subject matter of any one of Examples 7-10 can be arranged such that the first angular range extends in both a positive direction and a negative direction from a resting position.

In Example 12, the subject matter of any one of Examples 7-11 can optionally include a torsion spring.

Example 13 is an electronic device 100 comprising at least one electronic component 120, a chassis 160 comprising a first section 162 and a second section 164, the second section 164 coupled to the first section 162 by a hinge assembly 200, the hinge assembly 200 comprising a shaft 210, a bracket 220 to be rotatably mounted on the shaft 210. a first resistance element 230 to provide a first rotational resistance between the bracket 220 and the shaft 210 in a first angular range from a resting position, and a second resistance element 250 to provide a second rotational resistance between the bracket 220 and the shaft 210, greater than the first rotational resistance, in a second angular range, wherein the first resistance element 230 operates independently of the second resistance element 250.

In Example 14, the subject matter of Example 13 can optionally include a housing 232 defining a chamber 234, a visco-elastic element 236 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 15, the subject matter of any one of Examples 13-14 can optionally include a housing 232 defining a chamber 234, a spring 240 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 16, the subject matter of any one of Examples 13-15 can optionally include a housing 232 defining a chamber 234 which is to contain a fluid, a bias mechanism 240 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 17, the subject matter of any one of Examples 13-16 can be arranged such that the first angular range extends in both a positive direction and a negative direction from a resting position.

In Example 18, the subject matter of any one of Examples 13-17 can optionally include a torsion spring.

Example 19 is an electronic device 100, comprising at least one electronic component 120, a chassis 160 comprising a first section 162 and a second section 164, the second section 164 coupled to the first section 162 by a hinge assembly 200, the hinge assembly 200 comprising a shaft 210, a bracket 220 to be rotatably mounted on the shaft 210, means to provide a first rotational resistance between the bracket 220 and the shaft 210 in a first angular range from a resting position and means to provide a second rotational resistance between the bracket 220 and the shaft 210, greater than the first rotational resistance, in a second angular range.

In Example 20, the subject matter of Example 19 can optionally include a housing 232 defining a chamber 234, a visco-elastic element 236 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 21, the subject matter of any one of Examples 19-20 can optionally include a housing 232 defining a chamber 234, a spring 240 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 22, the subject matter of any one of Examples 19-21 can optionally include a housing 232 defining a chamber 234 which is to contain a fluid, a bias mechanism 240 disposed at a first end of the chamber 234, and a piston 238 disposed at a second end of the chamber 234, wherein rotation of the bracket 220 about the shaft 210 translates the piston 238 laterally in the housing 232 on a first side of the chamber 234.

In Example 23, the subject matter of any one of Examples 19-22 can be arranged such that the first angular range extends in both a positive direction and a negative direction from a resting position.

In Example 24, the subject matter of any one of Examples 19-23 can optionally include a torsion spring.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A hinge assembly, comprising:
a shaft;
a bracket to be rotatably mounted on the shaft;
a first resistance element to provide a first rotational resistance between the bracket and the shaft in a first angular range from a resting position; and
a second resistance element to provide a second rotational resistance between the bracket and the shaft, greater than the first rotational resistance, in a second angular range, wherein the first resistance element operates independently of the second resistance element.

2. The hinge assembly of claim 1, wherein the first resistance element comprises:
a housing defining a chamber;
a visco-elastic element disposed at a first end of the chamber; and
a piston disposed at a second end of the chamber, wherein rotation of the bracket about the shaft translates the piston laterally in the housing on a first side of the chamber.

3. The hinge assembly of claim 1, wherein the first resistance element comprises:
a housing defining a chamber;
a spring disposed at a first end of the chamber; and
a piston disposed at a second end of the chamber, wherein rotation of the bracket about the shaft translates the piston laterally in the housing on a first side of the chamber.

4. The hinge assembly of claim 1, wherein the first resistance element comprises:
a housing defining a chamber which is to contain a fluid;
a bias mechanism disposed at a first end of the chamber; and
a piston disposed at a second end of the chamber, wherein rotation of the bracket about the shaft translates the piston laterally in the housing on a first side of the chamber.

5. The hinge assembly of claim 1, wherein first angular range extends in both a positive direction and a negative direction from a resting position.

6. The hinge assembly of claim 1, wherein the second resistance element comprises a torsion spring.

7. A chassis for an electronic device, comprising:
a first section and a second section, the second section coupled to the first section by a hinge assembly, the hinge assembly comprising;
a shaft;
a bracket to be rotatably mounted on the shaft;
a first resistance element to provide a first rotational resistance between the bracket and the shaft in a first angular range from a resting position; and
a second resistance element to provide a second rotational resistance between the bracket and the shaft, greater than the first rotational resistance, in a second angular range, wherein the first resistance element operates independently of the second resistance element.

8. The chassis of claim 7, wherein the first resistance element comprises:
a housing defining a chamber;
a visco-elastic element disposed at a first end of the chamber; and
a piston disposed at a second end of the chamber, wherein rotation of the bracket about the shaft translates the piston laterally in the housing on a first side of the chamber.

9. The chassis of claim 7, wherein the first resistance element comprises:
a housing defining a chamber;
a spring disposed at a first end of the chamber; and
a piston disposed at a second end of the chamber, wherein rotation of the bracket about the shaft translates the piston laterally in the housing on a first side of the chamber.

10. The chassis of claim 7, wherein the first resistance element comprises:
a housing defining a chamber which is to contain a fluid;
a bias mechanism disposed at a first end of the chamber; and
a piston disposed at a second end of the chamber, wherein rotation of the bracket about the shaft translates the piston laterally in the housing on a first side of the chamber.

11. The chassis of claim 7, wherein first angular range extends in both a positive direction and a negative direction from a resting position.

12. The chassis of claim 7, wherein the second resistance element comprises a torsion spring.

13. An electronic device, comprising:
at least one electronic component;
a chassis comprising a first section and a second section, the second section coupled to the first section by a hinge assembly, the hinge assembly comprising;
a shaft;
a bracket to be rotatably mounted on the shaft;
a first resistance element to provide a first rotational resistance between the bracket and the shaft in a first angular range from a resting position; and
a second resistance element to provide a second rotational resistance between the bracket and the shaft, greater than the first rotational resistance, in a second angular range, wherein the first resistance element operates independently of the second resistance element.

14. The electronic device of claim 13, wherein the first resistance element comprises:
a housing defining a chamber;
a visco-elastic element disposed at a first end of the chamber; and
a piston disposed at a second end of the chamber, wherein rotation of the bracket about the shaft translates the piston laterally in the housing on a first side of the chamber.

15. The electronic device of claim 13, wherein the first resistance element comprises:
a housing defining a chamber;
a spring disposed at a first end of the chamber; and
a piston disposed at a second end of the chamber, wherein rotation of the bracket about the shaft translates the piston laterally in the housing on a first side of the chamber.

16. The electronic device of claim 13, wherein the first resistance element comprises:
a housing defining a chamber which is to contain a fluid;
a bias mechanism disposed at a first end of the chamber; and
a piston disposed at a second end of the chamber, wherein rotation of the bracket about the shaft translates the piston laterally in the housing on a first side of the chamber.

17. The electronic device of claim 13, wherein first angular range extends in both a positive direction and a negative direction from a resting position.

18. The electronic device of claim 13, wherein the second resistance element comprises a torsion spring.

19. An electronic device, comprising:
at least one electronic component;
a chassis comprising a first section and a second section, the second section coupled to the first section by a hinge assembly, the hinge assembly comprising;
a shaft;
a bracket to be rotatably mounted on the shaft;
means to provide a first rotational resistance between the bracket and the shaft in a first angular range from a resting position; and
means to provide a second rotational resistance between the bracket and the shaft, greater than the first rotational resistance, in a second angular range.

20. The electronic device of claim 19, wherein the means to provide a first rotational resistance comprises:
a housing defining a chamber;
a visco-elastic element disposed at a first end of the chamber; and
a piston disposed at a second end of the chamber, wherein rotation of the bracket about the shaft translates the piston laterally in the housing on a first side of the chamber.

21. The electronic device of claim 19, wherein the means to provide a first rotational resistance comprises:
a housing defining a chamber;
a spring disposed at a first end of the chamber; and
a piston disposed at a second end of the chamber, wherein rotation of the bracket about the shaft translates the piston laterally in the housing on a first side of the chamber.

22. The electronic device of claim 19, wherein the means to provide a first rotational resistance comprises:
a housing defining a chamber which is to contain a fluid;
a bias mechanism disposed at a first end of the chamber; and
a piston disposed at a second end of the chamber, wherein rotation of the bracket about the shaft translates the piston laterally in the housing on a first side of the chamber.

23. The electronic device of claim 19, wherein first angular range extends in both a positive direction and a negative direction from a resting position.

24. The electronic device of claim 19, wherein the means to provide a second rotational resistance comprises a torsion spring.
